(19) United States
(12) Patent Application Publication
(10) Pub. No.: US 2026/0318753 A1
(43) Pub. Date: Oct. 15, 2026

(54) METHODS AND SYSTEMS FOR MITIGATING NOISE FOR MICROWAVE REMOTE SENSING

(71) Applicant: BAE Systems Space & Mission Systems Inc., Broomfield, CO (US)

(72) Inventors: Michael Stephen Hersman, Parker, CO (US); Sean Robert Geiger, Louisville, CO (US)

(73) Assignee: BAE Systems Space & Mission Systems Inc., Broomfield, CO (US)

(21) Appl. No.: 19/467,396

(22) Filed: Feb. 2, 2026

Related U.S. Application Data
(63) Continuation-in-part of application No. 17/957,115, filed on Sep. 30, 2022, now Pat. No. 12,540,864.
(60) Provisional application No. 63/251,474, filed on Oct. 1, 2021.

(51) Int. Cl. G01K 11/00; G01K 15/00; G01S 13/95; G01W 1/18

(52) U.S. Cl. CPC G01K 11/006; G01K 15/005; G01S 13/958; G01W 1/18

(57) ABSTRACT

Radiometer systems and methods that mitigate flicker (1/f) noise are provided. A microwave radiometer system with accuracy impacted by 1/f noise comprises active components which, between measurements, are powered off and on. By powering the active components off and on, 1/f noise is mitigated. Disclosed systems and methods include performing a first measurement with a sensor of a radiometer, after performing the first measurement, switching power to one or more active components of the radiometer off, the active components comprising one or more of an amplifier, a square law detector, and an A/D converter, after switching the power to the one or more active components off, switching the power to the one or more active components on, and after switching the power to the one or more active components on, performing a second measurement with the sensor.

### CROSS-REFERENCE TO RELATED APPLICATION

This application is a continuation-in-part of U.S. patent application Ser. No. 17/957,115, filed Sep. 30, 2022, which claims the benefit of U.S. Provisional Application Serial Number 63/251,474, filed Oct. 1, 2021, the entire disclosure of each of which is hereby incorporated herein by reference.

### FIELD

The present disclosure relates generally to radiometry, and more particularly to mitigating flicker noise in radiometers.

### BACKGROUND

Radiofrequency (“RF”) and microwave systems include microwave radiometers which accurately measure the microwave power at the input of the system. This power level is proportional to temperature and can be used to estimate physical temperature by comparing scene measurements to calibration measurements using targets of known temperature.

One common use of microwave radiometers is for remote sensing from orbit. In one approach, known as a total power radiometer, a radiometer utilizes a scanning antenna to scan across the earth, making multiple measurements during the scan. At the end of each scan, the radiometer is calibrated using known temperature targets. Typical timing parameters are ten milliseconds/measurement with a calibration interval of two seconds. It is critical that the radiometer is stable during the time period between calibrations. Any changes in gain or internal noise level during this calibration period cause errors in the measurements which cannot be removed with the calibrations.

Two sources of uncertainty, referred to as the “delta-T,” in radiometric measurements are of interest here. The first source is the fluctuation due to fundamental limitations in forming a power estimate of a Gaussian thermal noise signal. This has a uniform power spectrum and is known as “white noise.” This fluctuation can be reduced by increasing the measurement, or integration, time or increasing the bandwidth of the noise signal being measured. The second source of uncertainty is low frequency noise which may have a 1/f power spectrum density slope when plotted against frequency. This flicker (“1/f”) noise is a fundamental property of all electronics circuits but is of particularly concern in analog circuitry present in high-precision measurement systems, and so can be a significant contributor to uncertainty in radiometer measurements. This low frequency noise comes from gain drifts and other fundamental processes in electronic circuits. The noise acts within the calibration interval timeframe, cannot be reduced by increasing integration time and bandwidth, and so places fundamental limitations on the radiometer performance.

While 1/f noise is always present in electronic circuits, some materials exhibit high noise levels which require a solution. In systems using indium phosphide (“InP”) amplifiers in particular, necessary for amplifying frequencies over ~90 GHz, 1/f noise can cause significant performance degradation.

One approach to reducing the impact of 1/f noise is known as Dicke switching. See M. Ogut, et al.,“A Novel 1/f Noise Mitigation Technique Applied to a 670 GHz Receiver,” Journal of the IEEE on Transactions on Terahertz Science and Technology, vol. 11, no. 1, at 109-112, Jan. 2021.Dicke switching requires making rapid measurements of both the signal and a stable reference. While Dicke switching can reduce or eliminate the 1/f contribution, Dicke switching reduces the measurement time by the time spent measuring the reference and suffers from a factor of 2 degradation in white noise contribution, resulting in an overall delta-T degradation and increased uncertainty and sensitivity in the final measurements of the instrument.

What is needed is a way to reduce or eliminate 1/f noise without incurring a degradation in sensitivity.

### SUMMARY

Embodiments of the present disclosure provide methods and systems for reducing or eliminating 1/f noise in radiometers. As disclosed herein, a method of reducing or eliminating 1/f noise in a radiometer may comprise power-cycling elements within the radiometer, such as amplifiers, analog-to-digital (“A/D”) converters, a square law detector, etc., between each measurement taken by the radiometer. By turning active components such as A/D converters, amplifiers, a power measurement device, such as a square law detector, etc., off and on for each measurement, the radiometer may effectively start clean with each measurement and long-term effects of 1/f noise, which may degrade the resulting estimate, may be eliminated. By operating a radiometer using a power-cycling method as described herein, an estimate of scene temperature may be obtained with reduced noise as compared to conventional radiometer systems.

Conventional radiometer systems may include power-cycling the input stage amplifier to create a Dicke reference. This has been demonstrated where it is impractical to insert a microwave switch due to high insertion loss. In such a system, during the measurement time, on the order of, for example, ten milliseconds, a number of measurements of a signal and a reference may be made. While creating a Dicke reference can help reduce 1/f noise, the Dicke reference process causes a degradation of the precision of the system by a factor of two because half of the measurement time is used to measure a reference instead of the actual signal, i.e., the unknown quantity.

As described herein, a process of rapidly turning off and on power to components within a radiometer system between each measurement, and without making a measurement of the off-state, using power-cycling to reset the system for every measurement reduces or eliminates 1/f noise without suffering from a loss in precision as compared to a Dicke reference system. When components within a radiometer system are turned off and on, the system should be in a similar initial state for every measurement. In this way, any long-term memory effects that cause issues in conventional systems can be avoided. Since the time required to power cycle the components is much less than the measurement time and can be accomplished during reset and data read intervals between measurements, there is no reduction in integration time and associated increase in measurement uncertainty.

Silicon chips and other substrates for semiconductors, such as gallium arsenide, gallium nitride, and InP, exhibit 1/f noise where the gain will vary randomly over time. Use of these technologies is necessary at high frequencies, because the 1/f noise contributed by these technologies becomes an issue which needs to be corrected. By removing power to active electronics, which use a 1/f noise-prone technology such as InP, and then re-applying the power a period of time later, e.g., ten to one hundred microseconds, 1/f noise can be reduced or eliminated. By consistently re-applying the power to active electronics (for example in the electronic gain stage) only for the remainder of the time interval (e.g., ten milliseconds), 1/f noise may thereby be reduced during the calibration interval, and the measurement may be taken as normal with reduced or eliminated 1/f noise.

Systems and methods as described herein may be used in at least one embodiment in relation to a radiometer with a scanning antenna on a satellite used to scan over the earth. A reflector may rotate over a period of time, e.g., once every two seconds, and a reflector beam may sweep out a path on the ground over each rotation. Measurements of scene temperatures may be made on intervals, such as ten milliseconds. In this way, scene temperature contours may be created, in the form of a raster scan that gets calibrated at the end of each sweep. Each measurement represents a beam traveling across an area for around ten milliseconds, which would allow for about 200 measurements in a 2-second calibration interval. This time includes measurements of the scene, measurements of the hot and cold references, and unused time to transition between the calibration and scene measurements.

Without the systems and methods described herein, gain variations caused by 1/f noise may cause errors or inaccuracies in the measurements. For example, using the systems and methods described herein, following every measurement interval, e.g., every 10 milliseconds, the power electronics within the radiometer system may be shut off for a period of time, e.g., for 10 microseconds, and restart before the next measurement is made. By power cycling components within the radiometer system in this way, 1/f noise can be mitigated.

During the off-state between measurements, in which power to electrical components is switched off, no off-state reference is measured. Because the off-state is very brief, e.g., 10 microseconds, relative to the measurement interval, e.g., 10 milliseconds, and no measurements take place during the off-state, the vast majority of the available duty cycle time (e.g., 10 milliseconds of each 10.01 millisecond period) can be spent measuring the actual scene or performing hot or cold calibration. In this way, a more precise measurement may be made while avoiding any unwanted electronic component memory issues which cause 1/f noise.

As disclosed herein, power cycling may be used to mitigate, reduce, or eliminate 1/f noise contribution from the first stage or stages of the radiometer system. Power-cycling a receiver during the first stages reduces 1/f contribution independent of Dicke switching architectures. By power-cycling briefly between measurements with a total power radiometer, 1/f noise may be reduced without suffering the factor of 2 degradation in sensitivity which occurs with conventional Dicke radiometer systems.

Embodiments of the present disclosure include: a method of using a radiometer, the method comprising: performing a first series of measurements with a sensor of the radiometer; after performing the first series of measurements, switching power to one or more active components of the radiometer off, the active components comprising one or more of an amplifier, a power measurement device, and an A/D converter; processing the first series of measurements using a digital signal processing device to reconstruct a signal spectrum based on the first series of measurements; after switching the power to the one or more active components off, switching the power to the one or more active components on; and after switching the power to the one or more active components on, performing a second series of measurements with the sensor.

Aspects include wherein processing the first series of measurements is performed in parallel with at least one of switching the power to the one or more active components off and switching the power to the one or more active components on.

Aspects include wherein the method further includes down-converting frequencies associated with the first series of measurements to lower frequencies.

Aspects include wherein the lower frequencies are associated with a sampling rate of the A/D converter.

Aspects include wherein the measurements are associated with a spectrum of frequencies, and the reconstructing of the signal spectrum comprises recreating a portion of the sampled spectrum of frequencies.

Aspects include wherein the portion of the sampled spectrum is associated with a Nyquist zone.

Aspects include wherein reconstructing the signal spectrum comprises performing a fast-Fourier transform (“FFT”).

Aspects include wherein the method further includes filtering the reconstructed signal spectrum into a plurality of sub-bands.

Aspects include wherein the method further includes outputting the plurality of sub-bands to a digital receiver.

Aspects include wherein the second series of measurements is performed about ten microseconds after the first series of measurements is performed.

Aspects include wherein the first and second series of measurements are measurements of a scene temperature.

Aspects include wherein the method further includes building a raster scan of a scene based at least in part on the first series of measurements.

Aspects include wherein the method further includes, after switching the power to the one or more active components off and prior to switching the power to the one or more active components on, waiting a period of time sufficient for a voltage within each of the one or more active components to reach zero.

Aspects include wherein each of the first and second series of measurements are associated with one or more of atmospheric noise power, radiant energy emitted from a ground, solar radiation, and sensor calibration.

Aspects include wherein the one or more active components comprise one or more input amplifiers.

Aspects include wherein the one or more active components comprise one or more A/D converters.

Aspects include wherein the second series of measurements comprises no additional 1/f noise as compared to the first series of measurements.

Aspects include wherein the method further includes performing a series of hot calibration measurements and a series of cold calibration measurements prior to performing the first series of measurements.

Embodiments of the present disclosure include: a computer program product comprising: a non-transitory computer-readable storage medium having computer-readable program code embodied therewith, the computer-readable program code configured, when executed by a processor, to execute a method, the method comprising: performing a first series of measurements with a sensor of the radiometer; after performing the first series of measurements, switching power to one or more active components of the radiometer off, the active components comprising one or more of an amplifier, a power measurement device, and an A/D converter; processing the first series of measurements using a digital signal processing device to reconstruct a signal spectrum based on the first series of measurements; after switching the power to the one or more active components off, switching the power to the one or more active components on; and after switching the power to the one or more active components on, performing a second series of measurements with the sensor.

Embodiments of the present disclosure include: a controller for a radiometer, the controller comprising one or more circuits to: perform a first series of measurements with a sensor of the radiometer; after performing the first series of measurements, switch power to one or more active components of the radiometer off, the active components comprising one or more of an amplifier, a power measurement device, and an A/D converter; process the first series of measurements using a digital signal processing device to reconstruct a signal spectrum based on the first series of measurements; after switching the power to the one or more active components off, switch the power to the one or more active components on; and after switching the power to the one or more active components on, perform a second series of measurements with the sensor.

Additional features and advantages of embodiments of the present disclosure will become more readily apparent from the following description, particularly when considered together with the accompanying drawings.

### BRIEF DESCRIPTION OF THE DRAWINGS

FIG. 1 depicts an example scenario in which a radiometer implementing a process in accordance with embodiments of the present disclosure is used to obtain data;

FIG. 2 depicts components of an example radiometer system in accordance with embodiments of the present disclosure;

FIG. 3A depicts components of a conventional radiometer system;

FIG. 3B depicts an output of a conventional radiometer system;

FIG. 4A depicts components of a conventional Dicke reference radiometer system;

FIG. 4B depicts an output of a conventional Dicke reference radiometer system;

FIG. 5A depicts components of a radiometer system in accordance with embodiments of the present disclosure;

FIG. 5B depicts a timeline of radiometer measurements in accordance with embodiments of the present disclosure;

FIG. 6 is a flowchart depicting aspects of a process for mitigating the effect of 1/f noise on data obtained using a radiometer in accordance with embodiments of the present disclosure;

FIG. 7 depicts a timeline and signal spectrum in accordance with embodiments of the present disclosure; and

FIG. 8 is a flowchart depicting aspects of a process in accordance with embodiments of the present disclosure.

### DETAILED DESCRIPTION

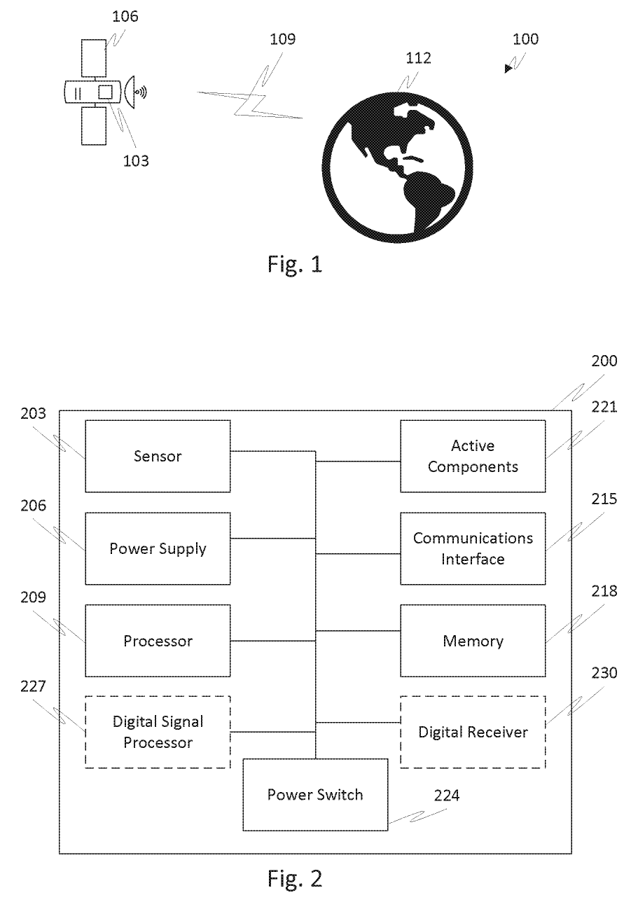

As shown in FIG. 1, a radiometer system 103 may be implemented in an environment 100 by mounting the radiometer system 103 on a device such as a satellite 106 in orbit around a planet 112. It should be appreciated the environment 100 is shown for illustration purposes only and a radiometer system 103 as described herein may be used in a wide variety of applications and need not be mounted on any moving device. The radiometer system 103 may be configured to receive and measure signals 109 such as low-level thermal emission signals.

FIG. 2 depicts components of an example radiometer system 200 in accordance with embodiments of the present disclosure. In general, the system 200 depicted in FIG. 2 is in the form of a radiometer, for example such as may be carried by a satellite, space vehicle, or other mobile or stationary platform.

In some embodiments, a radiometer system 200 may comprise a number of elements as illustrated in FIG. 2. The radiometer system 200 may comprise a sensor 203 such as an infrared radiometer, microwave radiometer, or any type of sensor. The sensor 203 may be configured to estimate a power of any signal at the input of the sensor, such as power emitted by the atmosphere, power emitted from the ground, solar radiation, any man-made interference from transmitters, etc.

The sensor may be operated through the control of a processor 209 executing software or instructions stored in memory 218. The system 200 can additionally include a communications interface 215 and a power supply 206. The processor 209 can include a general purpose programmable processor, graphics processing unit (“GPU”), a field programmable gate array (“FPGA”), controller, or other processing device or set of devices capable of executing instructions for operation of the system 200. Instructions executed by the processor 209 can be stored as application programming in the memory 218. The memory 218 can include one or more volatile or nonvolatile solid-state memory devices such as but not limited to RAM, SDRAM, or the like. Alternatively, or additionally, the memory 218 can include one or more mass storage devices, such as, but not limited to, hard disk drives, optical storage devices, solid-state drives, or the like. In addition to providing storage for application programming, the memory 218 can store sensor data, intermediate or final data products, or other data or reference information, such as but not limited to collected sensor data.

The radiometer system 200 may also comprise a power supply 206. The power supply 206 may be configured to output power needed for active components 221 such as amplifiers, A/D converters, a power measurement device, such as a square law detector, etc., as well as other electric components such as the processor 209, etc. Power from the power supply 206 may be controlled by the processor 209 for example by turning on and off one or more power switches 224. The power supply 206 may be used to power-cycle one or more components 221 within the system 200 such as one or more of amplifiers and A/D converters. Power to components 221 may individually be controlled, such as through the use of switches enabling or disabling power supplied to each particular component 221. In some embodiments, a single switch may be used to control the power applied to one or more components 221, while in some embodiments, power may be turned off and on for all components 221 simultaneously.

The radiometer system 200 may comprise one or more processors 209 which may be configured to execute applications such as applications configured to measure power, calibrate the sensor 203, measure readings from the sensor 203, provide a clock signal for timing measurements and other intervals, etc.

The radiometer system 200 may also comprise one or more communications interfaces 215 configured to transmit data to and from the radiometer system 200. For example, the communications interface 215 may be used to read radiometer measurements from the system 200. In some embodiments, the radiometer system 200 may comprise a display configured to display a graphical user interface for displaying sensor measurements and other data.

The radiometer system 200 may further comprise one or more memory devices 218 configured to, for example, store sensor readings, application data, and other information. The memory devices 218 may be configured to be read and written by the processor 209.

In some embodiments, a radiometer system 200 may further include a digital signal processor (“DSP”) 227. A DSP 227 as described herein may be implemented as a dedicated digital signal processing device, as a programmable processor executing signal processing instructions, or as logic integrated within the processor 209 described above. A DSP 227 of a radiometer system 200 may receive digitized measurement data generated by one or more active components 221, such as an A/D converter, and may be configured to process a series of measurements acquired by a sensor 203. In some embodiments, a DSP 227 performs digital signal processing operations to reconstruct a frequency-domain representation of a received signal based on a plurality of time-domain samples collected during a measurement interval.

By way of example, a DSP 227 may process a series of high-speed samples corresponding to a scene measurement to re-create a portion of a sampled frequency spectrum. Such processing may include, without limitation, Fourier-based techniques, such as an FFT, or other mathematical operations suitable for converting a series of time-domain measurements into a spectral representation. The reconstructed frequency spectrum may correspond to a Nyquist zone defined by the sampling rate of one or more A/D converters and may include an entire sampled bandwidth, a region of a sampled bandwidth or one or more selected portions (or bands) thereof. In some embodiments, DSP 227 may further perform hyperspectral processing by identifying, filtering, or combining sub-bands of the reconstructed spectrum that are of interest for atmospheric sensing, weather observation, or other applications.

A radiometer system 200 may also include or be in communication with a digital receiver 230. A digital receiver 230 may receive processed spectral data from a DSP 227 of the radiometer system 200 or from another source. A digital receiver 230 may be configured to accept portions of a reconstructed spectrum and to further process, analyze, store, or transmit such data. In some embodiments, a digital receiver 230 may be used in place of or in addition to analog detection circuitry, such as square-law detectors.

In some implementations, signals received using the sensor 203 may be down-converted from a higher frequency range (e.g., 50-60 GHz) to a lower intermediate frequency range (e.g., 10-15 GHz) prior to digitization by an A/D converter included in active components 221. A DSP 227 and/or a digital receiver 230 may process the down-converted signals.

As described herein, a DSP 227 and/or a digital receiver 230 may operate in coordination with the processor 209 and memory 218 described above. For example, a processor 209 may control timing, power cycling, and sequencing of measurements, while a DSP 227 may perform spectral reconstruction and a digital receiver 230 may process the reconstructed spectral data. In some embodiments, processing of a previously acquired series of measurements by a DSP 227 may occur in parallel with power switching operations controlled by a power switch 224.

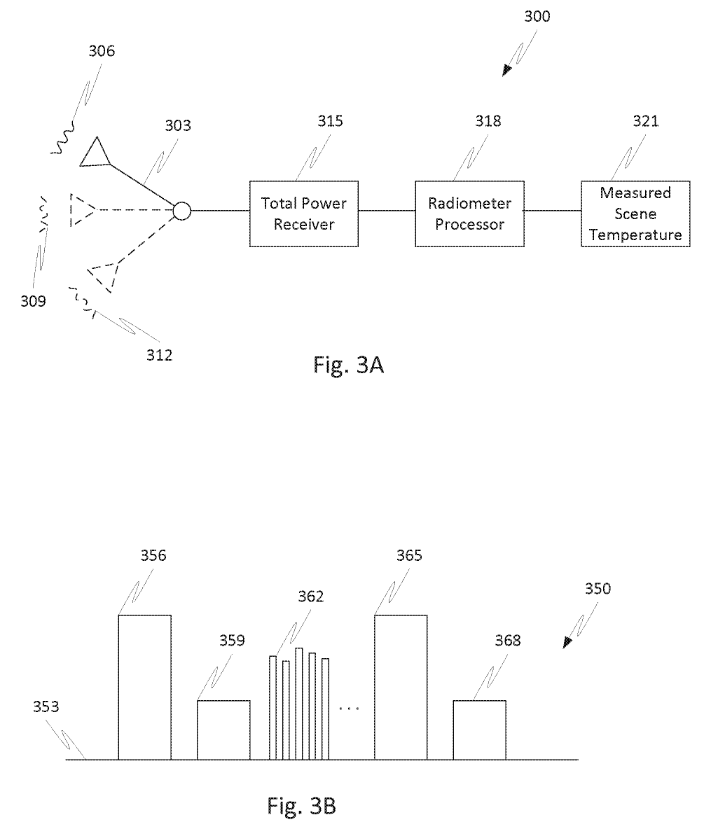

A conventional total power radiometer 300 is illustrated in FIG. 3A. A conventional total power radiometer 300 comprises a receiver arm 303 configured to selectively receive data from a scene 306, one or more cold calibration targets 309, and one or more hot calibration targets 312. Data as received by the receiver arm 306 may be received by a total power receiver 315 which may be processed and analyzed using a radiometer processor 318 to generate a measured scene temperature 321. A conventional total power radiometer 300 may be configured to measure a plurality of scene temperatures during a first period of time, e.g., one second, before and/or after measuring a hot calibration 312 and a cold calibration 309 for a second period of time, e.g., a quarter-second. The conventional total power radiometer 300 may then use the hot calibration as a first endpoint on a linear scale and the cold calibration 309 as a second endpoint on the linear scale to estimate a measurement of the scene temperature 306 by assigning a temperature to an average of the scene measurements by using a known approximately-linear relationship of the receiver 300. It should be appreciated that radiometer designs may incorporate small corrections to this linear relationship to provide better accuracy in measurements.

As illustrated in FIG. 3B, measurements 350 may be taken along a time scale 353. A hot calibration measurement 356 may be made for a first period of time, a cold calibration measurement 359 may be made for a second period of time, a plurality of scene measurements 362 may be made, each for a third period of time, a second hot calibration 365 may be made for a fourth period of time, and a second cold calibration 368 may be made for a fifth period of time. Each of the first through fifth periods of times may be the same or different depending on applications. Scene measurements 362 may be taken repeatedly on an interval until a particular desired or sufficient number of measurements have been made.

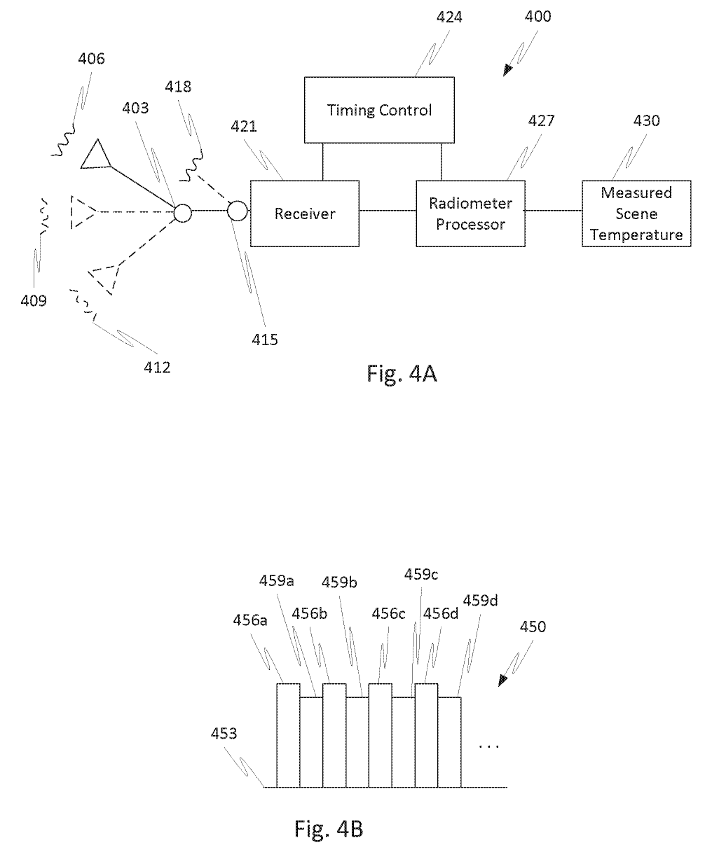

As illustrated in FIG. 4A, a conventional Dicke radiometer 400 may, similar to the conventional total power radiometer 300, comprise a signal arm 403 configured to selectively receive data from a scene 406, cold calibration 409, and hot calibration 412. Similar to the conventional total power radiometer 300, the Dicke radiometer 400 may take a plurality of scene measurements (e.g., 100 measurements) along with a cold calibration and a hot calibration, but during that time, the Dicke radiometer 400 may continuously switch between reading, with a total power receiver 421, the signal arm 403 (with the scene temperature, cold calibration, and hot calibration) and a Dicke reference arm 415 which may be configured to read a reference signal 418. During every measurement, (of a scene 406, cold calibration 409, and hot calibration 412) the radiometer 400 switches between the signal arm 403 and the Dicke reference arm 415 and takes a difference between the two measurements. One issue with a Dicke radiometer is that the amount of time in which the scene 406 is measured is reduced by half due to the Dicke reference. Reducing the amount of time the scene is measured reduces the quality of the measurements and the performance of the radiometer.

As illustrated in FIG. 4B, scene measurements 456a-d and Dicke reference measurements 459a-d of a Dicke radiometer may be taken along a time scale 453. A hot calibration measurement and a cold calibration measurement (not illustrated) may be taken before and/or after the scene measurements 456a-d and Dicke reference measurements 459a-d. Each scene measurement 456a-d may be captured using the signal arm 403 while each Dicke reference measurement 459a-d may be captured using the Dicke reference arm 415. As illustrated in FIG. 4B, the measurements of the scene 456a-d and the Dicke reference 459a-d may be switched repeatedly until a necessary number of measurements 456a-d, 459a-d have been captured depending on the application or desired accuracy. While a Dicke radiometer may reduce 1/f noise, a factor of two degradation in precision is incurred due to the switching between the Dicke reference signal and the scene signal and taking the difference between the two measurements.

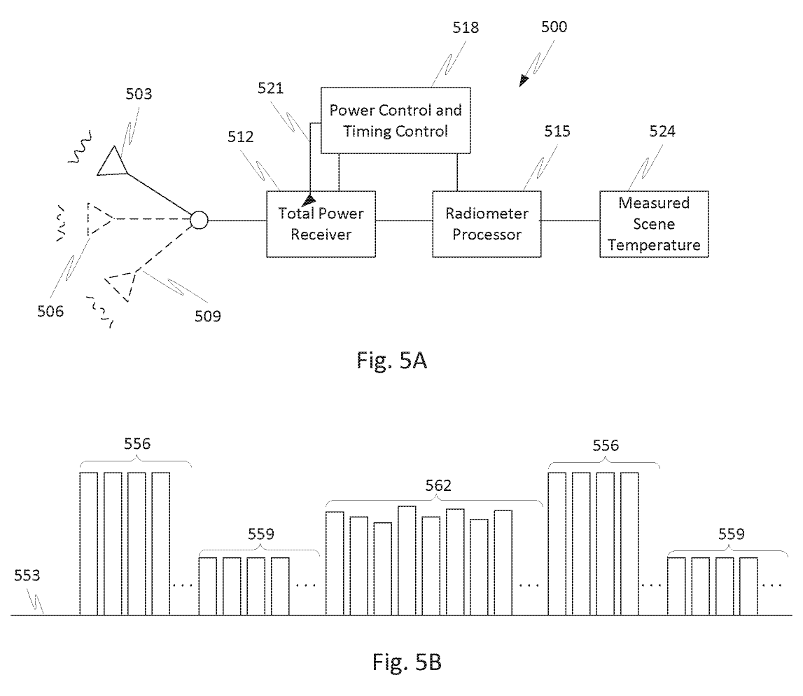

As illustrated in FIG. 5A, an exemplary radiometer system 500 may be operated in accordance with one or more of the embodiments described herein in such a way as to reduce or eliminate 1/f noise without incurring the same factor of two degradation in precision. The radiometer system 500 may be as illustrated in FIG. 2 and may comprise one or more power amplifiers, A/D converters, and other active components 221 within the radiometer. Depending on the application, certain active components may be powered off and on as part of the method 600. In the radiometer system 500, a power control and timing control system 518 may be used to power switch active components, such as amplifiers, A/D converters, a power measurement device, such as a square law detector, etc., of a total power receiver 512 to reset the active components 221 between each measurement. Because some delay of time is required between measurements for resetting the integrator and reading data, no time is sacrificed due to the resetting of the active components as described herein. As should be appreciated, using a radiometer as described herein, all of the available time is used in measuring the scene and no time is allocated to measuring a Dicke reference. The radiometer system 500 is further distinct from a Dicke radiometer 400 in that a second arm, i.e., the Dicke reference arm 415, is not required.

In accordance with one or more of the embodiments described herein, one or more active components, such as amplifiers (e.g., a 90-GHz amplifier, an input amplifier, or other type of amplifier), a power measurement device, such as a square law detector (e.g., a detection diode), A/D converters, bias sensor diodes, voltage references that feed into A/D converters, and/or other power-consuming elements of a radiometer 500 may be switched off and on before each measurement taken by the radiometer. In contrast to conventional radiometers, in which time is spent creating a Dicke reference or an estimate of the reference state or the power off state, using a radiometer as described herein virtually no time is wasted between measurements. Instead, time between measurements is leveraged to reset active components, eliminating or mitigating 1/f noise. Each time an active component is turned on, the active component will be in a new or fresh state. This new state can be expected to be the same for each measurement, thus removing or reducing any memory in the active component which causes 1/f noise.

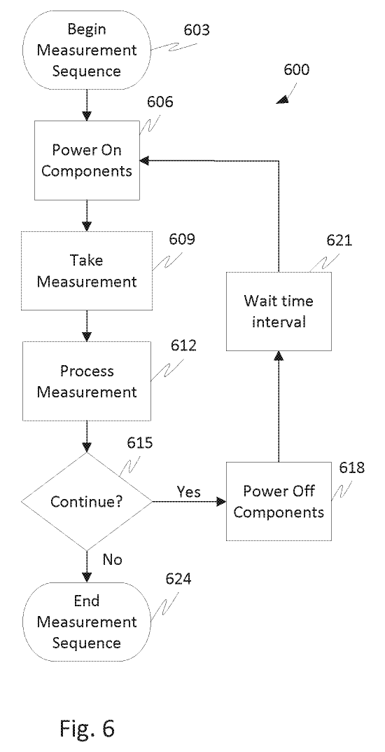

As illustrated in FIG. 5B, measurements including hot calibration 556, cold calibration 559, and scene measurements 562 may be taken along a timeline 553. Between each measurement 562, an amount of time, represented by the gaps between measurements 556, 559, 562, may be used to power off and on active components such as power amplifiers, A/D converters, a square law detector, etc. In some embodiments, each scene measurement 562 may last around 10 milliseconds and be separated by a gap of around ten microseconds in which the power switching may be performed. This gap may be similar to or the same as the wait time integral described below and illustrated in FIG. 6.

For illustration purposes, the timeline 553 of FIG. 5B shows an initial set of hot and cold calibration measurements 556, 559, followed by a set of scene measurements 562, and ending with a second set of hot and cold calibration measurements 556, 559. However, it should be appreciated that radiometers typically operate in a continually repeated measurement process. The second set of hot and cold calibration measurements 556, 559 may be followed by another set of scene measurements 562, another set of hot and cold calibration measurements 556, 559, or other measurements. In this way, a series of sets of scene measurements separated by calibration measurements may be captured.

Furthermore, while only four of each of the calibration measurements 556, 559, and eight scene measurements 562 are illustrated, it should be appreciated any number of measurements may be made in each set of hot and cold calibration measurements 556, 559, and scene measurements 562. Also, it should be appreciated that the widths, i.e., the time durations, of each of the measurements and the gaps between are not necessarily to scale. In some embodiments, each measurement may be around ten milliseconds separated by a time gap of around ten microseconds. In other embodiments, the measurements and/or time gaps may be other durations.

Using a system as described herein, measurements may be made for a high proportion of the time the radiometer 500 is operating. For example, in some embodiments, measurements may be made for 99% of the time and during only one percent of the time no measurement may be made while power to active components is switched off and on. It should be appreciated the percentage of time the power is turned off and on may be adjusted as needed. In at least one embodiment, active component power is turned off for one microsecond between measurements. The amount of time the power is switched off may be a function of how quickly the power supply, or the power held within certain active components such as amplifiers and A/D converters, can be dropped to zero volts and brought back to a proper power level.

Each measurement of the radiometer may be taken on an interval of, for example, ten milliseconds. In some embodiments, each calibration (hot and cold) may be a number of measurements, for example ten measurements each, and the scene itself may be measured, for example, one hundred times across a single scan. As successive measurements are made, one or more of the active components within the radiometer may be powered off and on. For example, the active components may be power-cycled every ten milliseconds—once for every measurement. Power may be switched off for a first period of time, e.g., ten microseconds, before the power is switched back on. Once the power is switched back on, a measurement may be taken, read, processed, etc., and the process may repeat. In some embodiments, during the time the power is switched off and back on, steps such as reading, processing, storing, or otherwise handling measurements may be performed in parallel.

As illustrated in FIG. 6, a method 600 of operating a radiometer in such a way as to reduce or eliminate 1/f noise, without incurring the factor of two degradation incurred by Dicke radiometer systems, may be performed using a radiometer system 500 as illustrated in FIG. 5A. The method 600 may begin with the radiometer system 500 being activated by a user, automatically being activated upon deployment, or otherwise activated. The radiometer system 500 may be onboard a satellite as illustrated in FIG. 1 or another device or may be stationary.

At 603, a measurement sequence may begin. In some embodiments, the measurement sequence may include hot and/or cold calibration and scene measurements. The measurement sequence may begin upon user command or may be automatically triggered in response to one or more events. In some embodiments, the measurement sequence may repeat on intervals. For example, a measurement sequence as described herein may comprise powering on active components, taking a measurement, and powering off the active components. A measurement sequence may include a measurement taken either for hot calibration, cold calibration, scene measurement, or other purpose. Between each of the measurements, active components may be reset. After a first measurement sequence is performed, a second measurement sequence may automatically begin, and in this way a series of measurements may be captured on intervals. A measurement sequence as described herein may be part of a series of measurements including sets of hot and/or cold calibration measurements followed by a series of one hundred, or another number, of scene measurements.

At 606, prior to taking a measurement, power may be applied to one or more active components of the radiometer system 500. The radiometer system 500 may be as illustrated in FIG. 2 and may comprise one or more power amplifiers, A/D converters, and other active components 221 within the radiometer. Depending on the application, certain active components may be powered off and on as part of the method 600. In some embodiments, applying power to a component may comprise turning on a power supply. In some embodiments, applying power may comprise switching a switch connecting a power supply to a component. It should be appreciated that in some embodiments, active components 221 may, upon initiating the measurement sequence, already be powered on. Powering on elements may only be required after the active components are actively powered off.

At 609, once the components to which the power is applied at 606 are powered-on to an adequate level, a measurement may be taken. The adequate level may be a particular voltage at which each element is rated to operate. In some embodiments, taking a measurement may comprise using a processor to receive data from a sensor. Depending on the application, each measurement may take a particular amount of time, such as ten milliseconds. In some embodiments, taking a measurement may comprise taking a measurement of a cold or hot calibration or of a scene. Measurements may be taken in sets. For example, hot calibration measurements may be taken in a set of ten, followed by a set of ten cold calibration measurements, followed by a set of one hundred scene measurements. Whether the measurement being taken is for calibration or for scene measurement purposes may affect the number of measurements taken. The numbers provided herein are for illustration purposes only and should not be considered as limiting in any way. Furthermore, the order of measurements, e.g., hot calibration before cold calibration before scene measurements, is provided as an example only and in practice the order could be altered in any way.

At 612, measurement data from the measurement taken at 609 may be processed and/or stored in memory. Processing a measurement from a sensor may comprise receiving measurement data from the sensor and storing the sensor data in memory. It should be appreciated that in some embodiments, the step 612 of processing the measurement may be optional and data may be processed at a later time.

At 615, the method 600 may comprise determining whether the measurements should continue. In some embodiments, the method 600 may continue until a particular number of measurements, such as one hundred measurements, have been made. If the method 600 is to continue with additional measurements, at 618 one or more active components 221 of the radiometer system 500, such as amplifiers, A/D converters, a square law detector, etc., may be powered off for a period of time. In some embodiments, powering off components may comprise turning off a power supply connected to each component. In some embodiments, powering off components may comprise switching off one or more switches. For example, each component to be powered off may be connected to a power supply via a switch. Each switch may be switched to turn power off to each component as necessary.

After powering off the active components 221 at 618, the method 600 may comprise waiting a particular amount of time at 621. This amount of time may be selected based on an amount of time required for active components being switched off to reach an internal voltage of or near zero. The interval may be selected based on characterized/best time durations. An amount of time may be selected such that the duration is sufficient to resolve 1/f noise and to generate the resetting feature w/o adversely affecting scene measurement time.

After waiting the amount of time at 621, the method 600 comprises powering on the active components 221 at 606. After the active components are powered, another measurement may be taken at 609. Each measurement as described herein may be a scene measurement, a hot calibration measurement, a cold calibration measurement, or another type of measurement.

In some embodiments, powering on the active components at 606 may comprise waiting an amount of time for the active components to be fully or sufficiently powered. Such an amount of time may be dependent on the active components being power cycled and the amount of time necessary for the active components to be sufficiently powered in order for a next measurement to be taken. In some embodiments, power may be switched off for around ten microseconds before the power is reapplied to the active components.

In some embodiments, the step of processing the measurement data at 612 may be performed in parallel with powering off the active components at 618 until the components are powered on at 606. By performing the processing and the power cycling in parallel, series of measurements can be taken with little to no unnecessary downtime. For example, if the active components are powered off for less than ten microseconds, each measurement may be captured about ten microseconds after the completion of a previous measurement. Using such a system, 1/f noise is reduced or eliminated without causing delay while avoiding any unnecessary delays.

While in conventional systems, successive measurements result in the buildup of 1/f noise, using a method 600 as described herein, each measurement will have little to no 1/f noise as compared to previous measurements.

If, at 615, the method 600 is to end, the method 600 may end at 624. At the end of the method 600, memory of the radiometer system may contain processed and/or raw sensor data as captured during the method 600 by the sensor of the radiometer system.

A radiometer as described herein may be implemented by detecting an incident signal directly at a sensor, or the incident signal may be converted to a different frequency to ease detection by the sensor. An implementation may include use of a downconversion circuit to reduce a high-frequency incident bandwidth, for example 50 to 60 GHz, to a lower frequency range, such as DC to 10 GHz, where sensors may be better able to detect and process signals within the spectrum. Downconversion may be particularly useful when used with sensors that comprise high-speed A/D converters.

A/D converters may be capable of sampling signals fast enough to allow measurements of wide bandwidths of downconverted spectrum, often multiple gigahertz or wider. Once the signal is sampled, digital signal processing techniques may allow for flexible and arbitrary processing of signals within the downconverted spectrum.

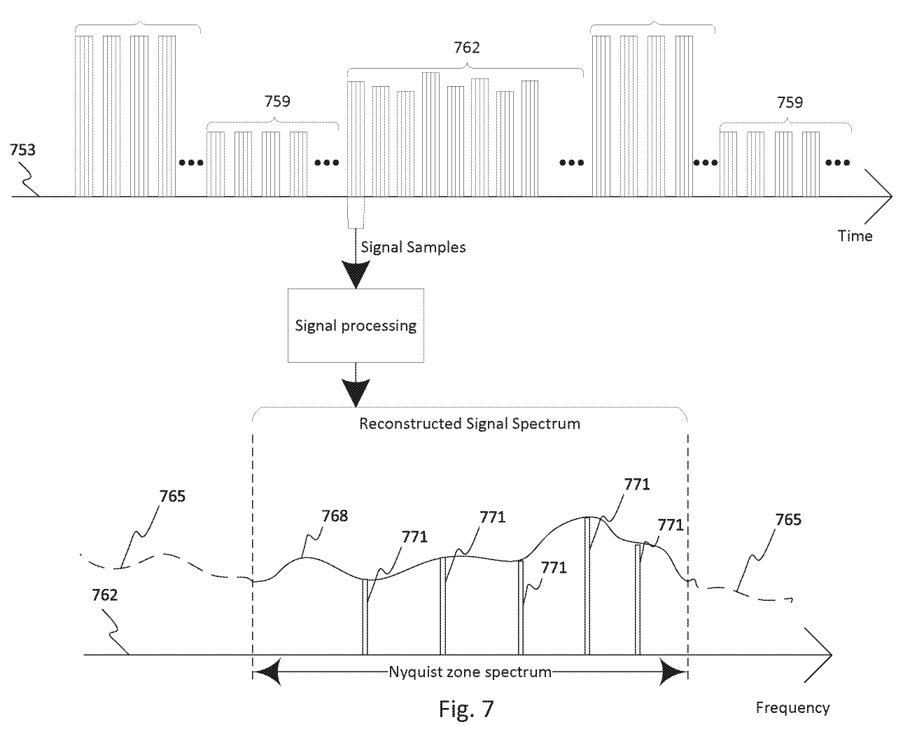

A radiometer may be implemented to utilize a series of high-speed measurements, such as measurements taken by a high-speed A/D converter, rather than a single measurement. Such a series of high-speed measurements may then be used through digital signal processing to re-create a portion of a sampled frequency spectrum, such as through FFT techniques. FIG. 7 illustrates an example of a series of high-speed measurements as members of a group of scene measurements, similar to the approach described above in relation to FIG. 5B. Although the series of measurements is depicted as a small number of samples for clarity, in practice the quantity of samples in each series may be much higher.

By way of example, signal samples may be generated through use of a 5 giga-sample-per-second A/D converter as the sensor. In this example, if the duration of one series of high-speed measurements is 10 milliseconds, approximately 50 million samples may be collected during that measurement interval and made available for further signal processing. Each series of high-speed measurements may correspond to a different location viewed by the radiometer, such as different portions of a scene as the radiometer scans over time.

Each series of measurements may be separated from an adjoining series by a gap time. The gap time may represent a period during which power is removed from, and then reapplied to, one or more active components of the radiometer to reduce flicker noise. Each series of measurements may be converted into a frequency spectrum through digital signal processing techniques. The frequency spectrum may represent the view of the radiometer at a time when the sensor arm is pointed at a particular location.

The bandwidth of the frequency spectrum, expressed in Hertz, may be limited to approximately half of the number of high-speed samples per second and may be referred to as a Nyquist zone, as established by the Nyquist–Shannon sampling theorem. For example, a 5 giga-sample-per-second A/D converter may allow processing of a Nyquist zone having a bandwidth of approximately 2.5 GHz. The reconstructed frequency spectrum may then be processed to provide measurements of specific arbitrarily narrow sub-bands as needed. Frequency spectrum portions outside of the Nyquist zone may be removed through filtering in electronic circuitry prior to signal sampling and digital signal processing.

An advantage of this type of spectral processing is that selected narrow portions of a spectrum may be analyzed to provide useful data inputs for a particular application, such as an atmospheric weather model. The technique of digitally processing arbitrary portions of a frequency spectrum in this manner may be referred to as hyperspectral sampling and processing.

Hot calibration measurement series and cold calibration measurement series may also be performed using the same radiometer system. The hot and cold calibration series of measurements may be processed in a manner similar to the scene measurements, or may instead be processed in a different manner, such as by mathematically averaging samples within each calibration series. Processing the calibration measurement series in the same manner as the scene measurement series may provide narrow hyperspectral sub-channel calibration values corresponding to specific frequencies.

A radiometer implementing high-speed series of measurements may be represented by FIG. 5A, with any amplifier, downconversion, filtering, and other analog circuitry contained in total power receiver 512, and with high-speed sampling and digital signal processing implemented in radiometer processor 515. Control of removing and applying power to active components to reduce flicker noise may be illustrated in this figure by power control and timing control 518.

The upper portion of FIG. 7 illustrates a sequence of measurements taken by a radiometer over time, with time progressing from left to right along timeline 753. The illustrated measurement sequence is similar to that described with respect to FIG. 5B, except that each measurement of FIG. 5B is a series of samples (e.g., acquired at a high sampling rate) rather than a single measurement. A radiometer may perform such measurements over a plurality of measurement series, with each series comprising multiple individual samples which may be collectively treated as a unit for processing.

In the example illustrated in FIG. 7, a first series of measurements 756 corresponds to measurements of a hot calibration source. Following the hot calibration series 756, a series of measurements 759 corresponds to measurements of a cold calibration source, such as deep space, and is illustrated with relatively lower signal amplitudes. A series of scene measurements 762 follows, representing measurements of a scene of interest, such as the Earth’s surface or atmosphere, as the radiometer views different portions of the scene over time. Additional hot calibration measurement series 756 and cold calibration measurement series 759 may be performed following a number of different scene measurement series 762 to periodically recalibrate the radiometer during operation.

Each measurement series 756, 759, and 762 comprises a plurality of individual signal samples acquired during a finite measurement interval while power is applied to one or more active components of the radiometer. Although only a limited number of samples are shown for clarity, each series may include a very large number of samples in practice, such as millions of samples acquired over a time period on the order of milliseconds when using a high-speed A/D converter. The grouping of samples into series reflects that the radiometer acquires and processes measurements in bursts, with each burst corresponding to a particular calibration state or scene.

After a given series of scene measurements is captured, the signal samples associated with a given measurement series, such as scene measurement series 762, may be provided to a signal processing stage. The signal processing stage may be implemented by a DSP, a processor, or another digital signal processing circuitry of (or in communication with) a radiometer. In some embodiments, processing of one series of measurements may occur while the radiometer prepares for or performs a subsequent measurement series. For example, the radiometer may switch power to active components off and on between each series of scene measurements and the signal processing may occur while the power is being switched off and on.

The signal processing stage may process the series of time-domain samples to reconstruct a signal spectrum associated with the measurements. Such processing may include digital signal processing operations that transform the time-domain samples into a frequency-domain representation. By way of example, the processing may include performing an FFT or another frequency-domain transformation using a plurality of samples in a series. The processing may be performed on samples obtained directly from an A/D converter or on samples that have been down-converted from a higher incident frequency range to a lower frequency range suitable for sampling by the A/D converter.

The lower portion of FIG. 7 illustrates an example of a reconstructed signal spectrum resulting from processing the scene measurement series 762. The reconstructed signal spectrum is shown as a function of frequency, with frequency increasing from left to right. The dashed rectangular region represents a Nyquist zone spectrum corresponding to the frequency bandwidth that may be reconstructed based on the sampling rate of the A/D converter. For example, when the A/D converter samples at a rate of N samples per second, the reconstructed spectrum may span frequencies up to approximately N/2, corresponding to a Nyquist zone.

Within the Nyquist zone spectrum, curve 768 represents a reconstructed spectral response of the measurements of a series. Portions of the spectrum outside the Nyquist zone, represented by regions 765, may not be reconstructed or may be ignored in the illustrated embodiment. In some implementations, the radiometer may focus processing on only a portion of the reconstructed spectrum rather than the entire Nyquist zone.

As further illustrated, the reconstructed signal spectrum may include a plurality of narrow spectral features or sub-bands 771. Such sub-bands may be identified, filtered, or otherwise extracted from the reconstructed spectrum using digital filtering or other digital signal processing techniques. In some embodiments, the reconstructed spectrum is filtered into a plurality of sub-bands, which may be processed independently or provided to a digital receiver for further analysis, storage, or transmission.

In some embodiments, a radiometer may perform hyperspectral processing in which sub-bands within the reconstructed spectrum are selected based on application-specific criteria. For example, sub-bands associated with particular atmospheric absorption characteristics may be selected and processed, while other portions of the spectrum are ignored. Multiple sub-bands may also be combined in some implementations to improve signal quality or to derive parameters of interest.

Although FIG. 7 illustrates reconstruction of a signal spectrum based on scene measurement series 762, similar processing may be applied to hot calibration measurement series 756 and cold calibration measurement series 759. In some embodiments, calibration series may be processed in the same manner as scene series to reconstruct calibration spectra. In other embodiments, the calibration series may instead be processed differently, such as by mathematically averaging samples within each calibration series to determine representative hot and cold calibration values. Such calibration values may then be used to correct, normalize, or otherwise process scene measurement results.

Accordingly, FIG. 7 illustrates how a radiometer may perform a series of measurements, digitize the measurements at a high sampling rate, process the resulting samples using digital signal processing to reconstruct a signal spectrum within a Nyquist zone, optionally filter the reconstructed spectrum into sub-bands, and use the reconstructed spectral information to support scene measurements, calibration, and hyperspectral processing.

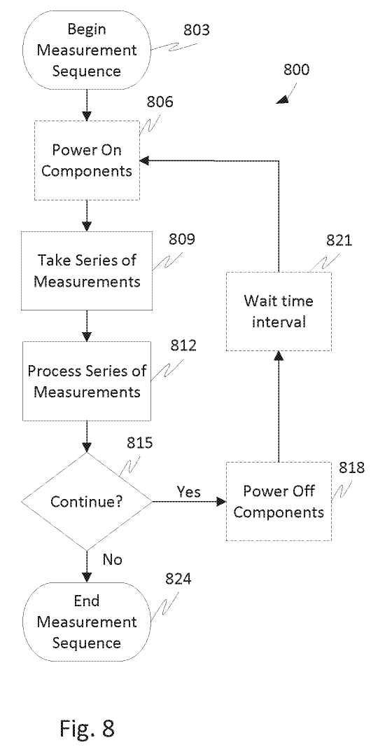

FIG. 8 is a flowchart illustrating an example method 800 for operating a radiometer using a series of measurements, with optional power-cycling between measurement series, in accordance with embodiments of the present disclosure. At 803, a measurement sequence is initiated. The measurement sequence may correspond to a set of calibration measurements, a scene scan, or a combination of calibration and scene measurements. In some embodiments, the measurement sequence may be initiated based on a timing schedule, a command from a processor, or detection of a particular condition.

At 806, one or more active components of the radiometer may optionally be powered on. Such active components may include, without limitation, one or more input amplifiers, A/D converters, power measurement devices, mixers, and/or other circuitry used to acquire measurements. In some implementations, the active components may already be powered on prior to beginning the measurement sequence, while in other implementations the components may be selectively powered on at the beginning of each measurement series to mitigate noise effects such as flicker noise.

After the active components are powered on, or if the power-on step is omitted, the method proceeds to 809, where the radiometer takes a series of measurements. The series of measurements may comprise a plurality of individual signal samples acquired over a measurement interval. The series may correspond to measurements of a scene of interest, a hot calibration source, or a cold calibration source. The measurements at 809 may include a number of samples, such as millions of samples, collected using an A/D converter operating at a multi-gigahertz sampling rate in some embodiments.

Following the series of measurements, the method proceeds to 812, where the series of measurements is processed. Processing may include digital signal processing operations performed by a processor, DSP, or other processing circuitry of the radiometer. In some embodiments, processing the series of measurements includes reconstructing a signal spectrum from the time-domain samples, such as by performing an FFT or another frequency-domain transformation. The reconstructed signal spectrum may correspond to a Nyquist zone defined by the sampling rate of the A/D converter. Processing may further include filtering the reconstructed signal spectrum into a plurality of sub-bands, selecting one or more sub-bands of interest, performing hyperspectral processing, and/or providing processed spectral data to a digital receiver.

After processing the series of measurements, the method proceeds to 815, where it is determined whether the measurement sequence should continue. Such a determination may be based on whether additional measurement series are required, such as additional scene measurements, additional calibration measurements, completion of a raster scan, or completion of a predetermined number of measurement cycles.

If the determination at 815 is that the measurement sequence should continue, the method may in some embodiments proceed to 818, where power to one or more active components of the radiometer is switched off. In implementations that include this step, switching power off between measurement series may reduce or reset accumulated noise, such as 1/f noise, in one or more active components.

After the optional power-off step, the method may proceed to 821, where a wait time interval is observed in some embodiments. During the wait time interval, the system may allow voltages within the active components to decay to zero or near zero before the components are powered on again. The duration of the wait time interval may be selected based on the characteristics of the active components and may be, for example, on the order of microseconds.

Following the wait time interval, or directly after 815 if the optional power-off and wait steps are omitted, the method returns to 806, where the active components may be powered on again prior to acquiring a subsequent series of measurements. In some embodiments, processing of a previously acquired series of measurements at 812 may occur in parallel with one or more of the power-off, wait, and power-on steps, thereby improving overall throughput of the radiometer.

If the determination at 815 is that the measurement sequence should not continue, the method proceeds to 824, where the measurement sequence ends. At this point, the radiometer may transition to another operating mode, output final measurement results, or await further instructions.

Accordingly, FIG. 8 illustrates a method in which a radiometer performs a series of measurements, processes the series of measurements using digital signal processing to reconstruct spectral information, and optionally cycles power to active components between measurement series, with optional wait intervals, to support accurate, low-noise radiometric measurements and flexible digital and hyperspectral processing.

The foregoing discussion of the disclosed systems and methods has been presented for purposes of illustration and description. Further, the description is not intended to limit the disclosed systems and methods to the forms disclosed herein. Consequently, variations and modifications commensurate with the above teachings, within the skill or knowledge of the relevant art, are within the scope of the present disclosure. The embodiments described herein are further intended to explain the best mode presently known of practicing the disclosed systems and methods, and to enable others skilled in the art to utilize the disclosed systems and methods in such or in other embodiments and with various modifications required by the particular application or use. It is intended that the appended claims be construed to include alternative embodiments to the extent permitted by the prior art.

What is claimed is:

1. A method of using a radiometer, the method comprising:
performing a first series of measurements with a sensor of the radiometer;
after performing the first series of measurements, switching power to one or more active components of the radiometer off, the active components comprising one or more of an amplifier, a power measurement device, and an analog-to-digital (A/D) converter;
processing the first series of measurements using a digital signal processing device to reconstruct a signal spectrum based on the first series of measurements;
after switching the power to the one or more active components off, switching the power to the one or more active components on; and
after switching the power to the one or more active components on, performing a second series of measurements with the sensor.

2. The method of claim 1, wherein processing the first series of measurements is performed in parallel with at least one of switching the power to the one or more active components off and switching the power to the one or more active components on.

3. The method of claim 1, further comprising down-converting frequencies associated with the first series of measurements to lower frequencies.

4. The method of claim 3, wherein the lower frequencies are associated with a sampling rate of the A/D converter.

5. The method of claim 1, wherein the measurements are associated with a spectrum of frequencies, and the reconstructing of the signal spectrum comprises recreating a portion of the sampled spectrum of frequencies.

6. The method of claim 5, wherein the portion of the sampled spectrum is associated with a Nyquist zone.

7. The method of claim 1, wherein reconstructing the signal spectrum comprises performing a fast-Fourier transform (FFT).

8. The method of claim 1, further comprising filtering the reconstructed signal spectrum into a plurality of sub-bands.

9. The method of claim 8, further comprising outputting the plurality of sub-bands to a digital receiver.

10. The method of claim 1, wherein the second series of measurements is performed about ten microseconds after the first series of measurements is performed.

11. The method of claim 1, wherein the first and second series of measurements are measurements of a scene temperature.

12. The method of claim 1, further comprising building a raster scan of a scene based at least in part on the first series of measurements.

13. The method of claim 1, further comprising, after switching the power to the one or more active components off and prior to switching the power to the one or more active components on, waiting a period of time sufficient for a voltage within each of the one or more active components to reach zero.

14. The method of claim 1, wherein each of the first and second series of measurements are associated with one or more of atmospheric noise power, radiant energy emitted from a ground, solar radiation, and sensor calibration.

15. The method of claim 1, wherein the one or more active components comprise one or more input amplifiers.

16. The method of claim 1, wherein the one or more active components comprise one or more A/D converters.

17. The method of claim 1, wherein the second series of measurements comprises no additional 1/f noise as compared to the first series of measurements.

18. The method of claim 1, further comprising performing a series of hot calibration measurements and a series of cold calibration measurements prior to performing the first series of measurements.

19. A computer program product comprising:
a non-transitory computer-readable storage medium having computer-readable program code embodied therewith, the computer-readable program code configured, when executed by a processor, to execute a method, the method comprising:
performing a first series of measurements with a sensor of the radiometer;
after performing the first series of measurements, switching power to one or more active components of the radiometer off, the active components comprising one or more of an amplifier, a power measurement device, and an analog-to-digital (A/D) converter;
processing the first series of measurements using a digital signal processing device to reconstruct a signal spectrum based on the first series of measurements;
after switching the power to the one or more active components off, switching the power to the one or more active components on; and
after switching the power to the one or more active components on, performing a second series of measurements with the sensor.

20. A controller for a radiometer, the controller comprising one or more circuits to:
perform a first series of measurements with a sensor of the radiometer;
after performing the first series of measurements, switch power to one or more active components of the radiometer off, the active components comprising one or more of an amplifier, a power measurement device, and an analog-to-digital (A/D) converter;
process the first series of measurements using a digital signal processing device to reconstruct a signal spectrum based on the first series of measurements;
after switching the power to the one or more active components off, switch the power to the one or more active components on; and
after switching the power to the one or more active components on, perform a second series of measurements with the sensor.
